(19) United States
(12) Patent Application Publication
(10) Pub. No.: US 2026/0181360 A1
(43) Pub. Date: Jun. 25, 2026

(54) DOWNLOADING DATA AT SPECIFIED LOCATIONS FOR VEHICLE SYSTEMS

(71) Applicant: TOYOTA JIDOSHA KABUSHIKI KAISHA, Aichi-ken (JP)

(72) Inventors: Keisuke SAWADA, Tokyo-to (JP); Mitsuo DATE, Funabashi-shi (JP)

(21) Appl. No.: 18/991,722

(22) Filed: Dec. 23, 2024

(51) Int. Cl. H04W 4/40; H04W 4/029; H04W 12/63

(52) U.S. Cl. CPC H04W 4/40; H04W 4/029; H04W 12/63

(57) ABSTRACT

Downloading data at specified locations is performed by displaying a user interface configured to receive a selection of geographic location for download performance; receiving, by a mobile computing network in a vehicle, a selected geographic location; receiving, by the mobile computing network, a download request; detecting a geographic location of the vehicle; and performing a download of the download request in response to determining that the geographic location of the vehicle matches the selected geographic location.

### BACKGROUND

Modern vehicles are becoming increasingly connected with external systems (e.g., cloud servers, traffic management systems, other vehicles, etc.) via wireless technologies like cellular networks, Wi-Fi, and satellite links. In modern connected vehicles, data comes from multiple sources and is used for various purposes, ranging from safety-critical functions to improving the user experience.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a system for downloading data at specified locations, according to at least one embodiment of the subject disclosure.

FIG. 2 is an operational flow for downloading data at specified locations, according to at least one embodiment of the subject disclosure.

FIG. 3 is an operational flow for displaying user interface, according to at least one embodiment of the subject disclosure.

FIG. 4 is a block diagram of a hardware configuration for downloading data at specified locations, according to at least some embodiments of the subject disclosure.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

When multiple types of data need to be downloaded, allowing users to downloading data at specified locations for vehicle systems enables vehicle updates and data transfers to happen efficiently and securely, improving the overall experience for the vehicle owner. The connectivity between modern vehicles with external servers via wireless technologies allows vehicles to receive real-time information, such as: navigation data (e.g., map data, route search results, surrounding information), traffic condition data (e.g., congestion reports, accident alerts), remote operation data and diagnostics (e.g., key lock/unlock, air conditioner on/off, alarm activation, battery status, vehicle health checks), software updates (e.g., for infotainment systems, safety features, autonomous driving software), weather data (e.g., forecasts for route planning), user-specific data related to vehicle management (e.g., settings for seats, mirrors, climate control, account authentication, database of voice recognition), entertainment data (e.g., music, video, image, web search), as well as emergency related data (e.g., emergency call, security patch). However, downloading multiple types of data at once can strain a vehicle's connectivity and processing resources. When download requests are received by a vehicle, the vehicle attempts to download irrespective of communication environment, leading to unnecessary computational resource consumption and cost. For example, downloading data for software updates while the user is driving the vehicle or performing the download in a rural area with limited cellular coverage will disrupt the user's driving experience. A user may desire performance of a download at a specific location, such as a home garage or a work parking lot, in consideration of communication environment (e.g., communication speed, bandwidth, signal strength and cost) and environment usage (e.g., on road or in a parking lot). Therefore, performing downloads of data at suitable locations is beneficial in enabling greater convenience, enhanced security and cost savings for the users, so that the vehicle remains safely and efficiently operable without disruptions during use. Performing downloads at specified locations also helps manage bandwidth limitations (e.g., cellular network speed, Wi-Fi range) to enable the vehicle to receive relevant information.

In at least some embodiments described herein, the solution to the above-mentioned problem is to download data at specified locations. That is, a location where download of data to a vehicle is performed is specified by a user via a user interface, and download of data is performed in the location specified by the user. In this way, downloads are performed by the vehicle at a location specified by the user. By specifying the geographic location for download, unnecessary consumption of computational resources and costs can be avoided.

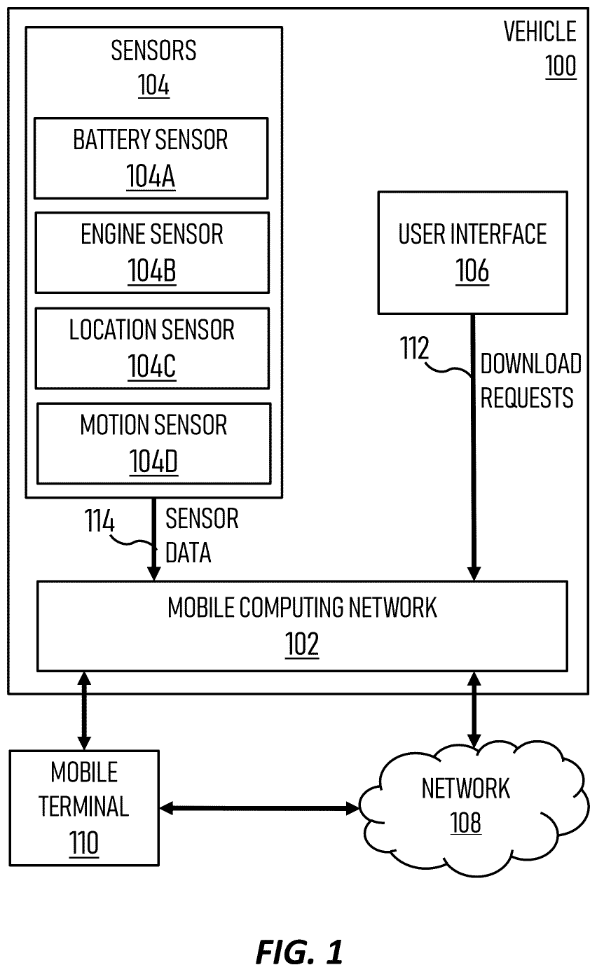

FIG. 1 is a schematic diagram of a system for downloading data at specified locations, according to at least one embodiment of the subject disclosure. The system includes a plurality of sensors 104, and a user interface 106 connected to a mobile computing network 102 within a vehicle 100. Vehicle 100 is further in communication with a mobile terminal 110 and a network 108 through mobile computing network 102. Sensors 104 include a battery sensor 104A, an engine sensor 104B, a location sensor 104C and a motion sensor 104D. Sensors 104 are configured to transmit sensor data 114 to mobile computing network 102. Mobile terminal 110 is in communication with network 108. User interface 106 is configured to transmit download requests 112 to mobile computing network 102. In at least some embodiments, mobile computing network 102, sensors 104, and user interface 106 are parts of a single device, such as vehicle 100.

In at least some embodiments, vehicle 100 is configured to transmit notifications and instructions to mobile terminal 110, and to receive an application from mobile terminal 110. In at least some embodiments, vehicle 100 is in communication with mobile terminal 110 through mobile computing network 102. In at least some embodiments, vehicle 100 is in communication with mobile terminal 110 through network 108. In at least some embodiments, vehicle 100 is an automobile or an autonomous vehicle.

In at least some embodiments, mobile computing network 102 is configured to receive download requests 112 from user interface 106, and to receive sensor data 114 from sensors 104. In at least some embodiments, mobile computing network 102 is an integration of wireless communication technologies and computing systems within vehicle 100 to support a variety of connected services, applications, and functions. In at least some embodiments, mobile computing network 102 is configured to enable vehicle 100 to interact with external systems (e.g., the internet, cloud services, other vehicles, or infrastructure), as well as support on-board systems that enhance the driving experience, safety, navigation, and overall functionality of vehicle 100. In at least some embodiments, mobile computing network 102 is a Controller Area Network (CAN), an Ethernet, a Peripheral Component Interconnect Express (PCIe) network, a Universal Serial Bus (USB) network, or a Local Internet Network (LIN).

Sensors 104 are configured to transmit sensor data 114 to mobile computing network 102. Sensors 104 include battery sensor 104A, engine sensor 104B, location sensor 104C and motion sensor 104D. In at least some embodiments, data types of sensor data 114 provided by battery sensor 104A, engine sensor 104B, location sensor 104C and motion sensor 104D are different. In at least some embodiments, battery sensor 104A is configured to detect a remaining capacity of a vehicle battery. In at least some embodiments, battery sensor 104A is configured to detect whether a charging operation is applied to the vehicle battery. In at least some embodiments, battery sensor 104A is configured to detect whether vehicle 100 is in a power saving mode. In at least some embodiments, engine sensor 104B is configured to detect if vehicle 100 is in a power-on state or a power-off state. In at least some embodiments, location sensor 104C is configured to detect the geographic location of vehicle 100. In at least some embodiments, location sensor 104C is configured to determine a precise position, orientation, and movement of vehicle 100 in real-time. In at least some embodiments, location sensor 104C is a GPS (Global Positioning System), an accelerometer, a gyroscope, a compass, etc. In at least some embodiments, motion sensor 104D is configured to detect a vehicle state of vehicle 100. In at least some embodiments, the vehicle state indicates whether vehicle 100 is running or stopped. In at least some embodiments, motion sensor 104D is configured to detect and measure the movement or acceleration of vehicle 100. In at least some embodiments, motion sensor 104D is configured to measure acceleration, angular velocity, and directional changes of vehicle 100. In at least some embodiments, motion sensor 104D is an accelerometer, a gyroscope, an Inertial Measurement Unit (IMU), a radar sensor, or a camera-based system.

User interface 106 is configured to transmit download requests to mobile computing network 102. In at least some embodiments, user interface 106 is configured to enable drivers, passengers, and other users to interact with the vehicle's various systems, technologies, and features. In at least some embodiments, user interface 106 is configured to enable selection of one location to perform all downloads or individual locations for certain downloads or downloads of certain data types. In at least some embodiments, user interface 106 is a smartphone, a touchscreen display, a voice control system, a Heads-Up Display (HUD), a gesture control, or a mobile integration and connectivity system. In at least some embodiments, user interface 106 is external to the vehicle.

In at least some embodiments, network 108 is configured to enable communications between mobile terminal 110 and mobile computing network 102 of vehicle 100. In at least some embodiments, network 108 is configured to connect vehicle 100 with external systems, other vehicles, or the cloud. In at least some embodiments, network 108 is configured to enable real-time data exchange, remote diagnostics, entertainment features, and advanced driver assistance systems (ADAS). In at least some embodiments, network 108 is a wired network, a 4G LTE network, a 5G network, or a Wi-Fi network that allows Vehicle-to-Vehicle (V2V) communication or Vehicle-to-Everything (V2X) communication.

Mobile terminal 110 is configured to communicate with vehicle 100 through mobile computing network 102 or network 108. In at least some embodiments, mobile terminal 110 is configured to receive notifications from vehicle 100. In at least some embodiments, mobile terminal 110 is configured to transmit applications to vehicle 100. In at least some embodiments, mobile terminal 110 is a portable device that is configured to connect to networks and exchange data. In at least some embodiments, mobile terminal 110 is a smartphone, a tablet, a smartwatch, a portable laptop, or smart glasses.

Download requests 112 are transmitted by user interface 106 to mobile computing network 102. In at least some embodiments, download requests 112 include requests for downloading applications or data related to operating system updates, entertainment, navigation, vehicle management, security and emergency, etc. In at least some embodiments, entertainment data includes music data, video data, and image data, etc. In at least some embodiments, navigation data includes map data, route search result data (if route search is performed in a server), surrounding information, and traffic conditions, etc. In least some embodiments, vehicle management data includes key lock/unlock, air conditioner on/off, and alarm activation, etc. In at least some embodiments, security data includes security patches. In at least some embodiments, emergency data includes emergency calls. In at least some embodiments, download requests 112 include requests for downloading applications or data related to web searches, account authentications, and database of voice recognitions, etc.

Sensor data 114 is transmitted by sensors 104 to mobile computing network 102. In at least some embodiments, sensor data 114 includes data of different data types, which are detected by different sensors of sensors 104. In at least some embodiments, the types of data are different depending on the sensor design. In at least some embodiments, sensor data 114 includes vehicle battery status data, vehicle state data, geographic location data, etc.

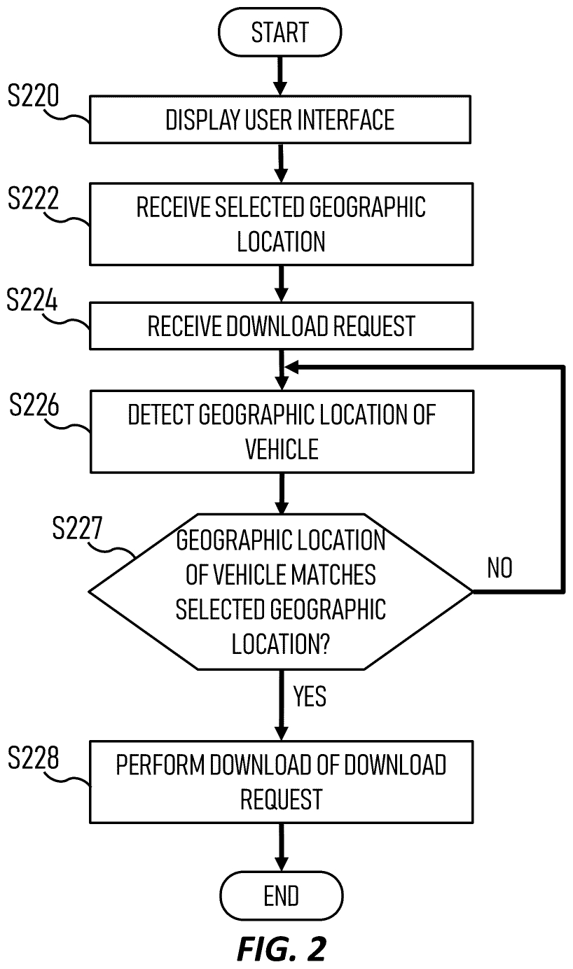

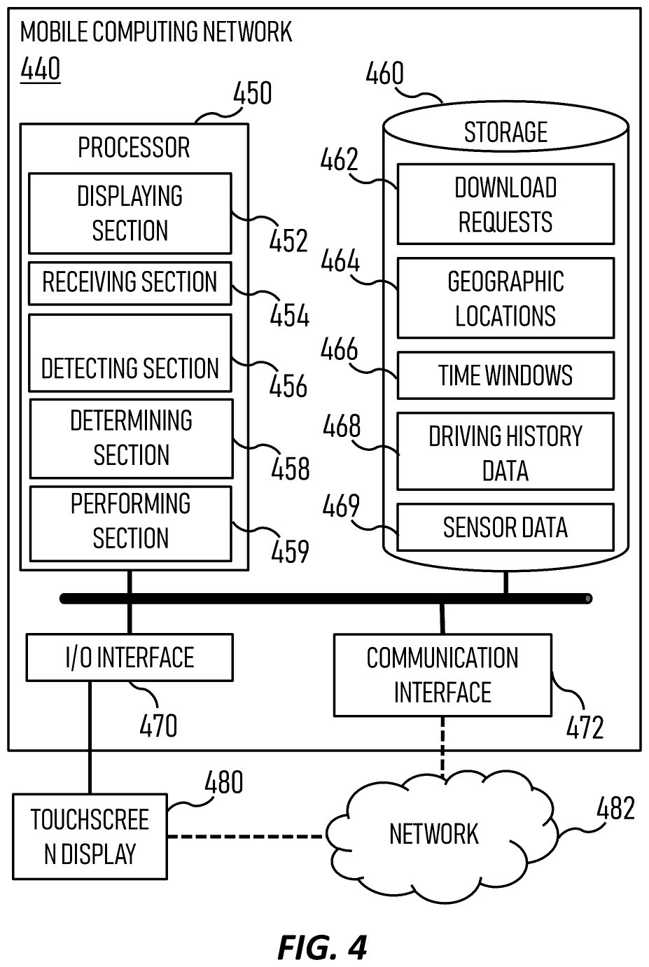

FIG. 2 is an operational flow for downloading data at specified locations, according to at least one embodiment of the subject disclosure. The operational flow provides a method of downloading data at specified locations. In at least some embodiments, the method is performed by a vehicle, such as vehicle 100 shown in FIG. 1, or a processor of an integrated circuit including sections for performing certain operations, such as the processor 450 shown in FIG. 4, which will be explained hereinafter.

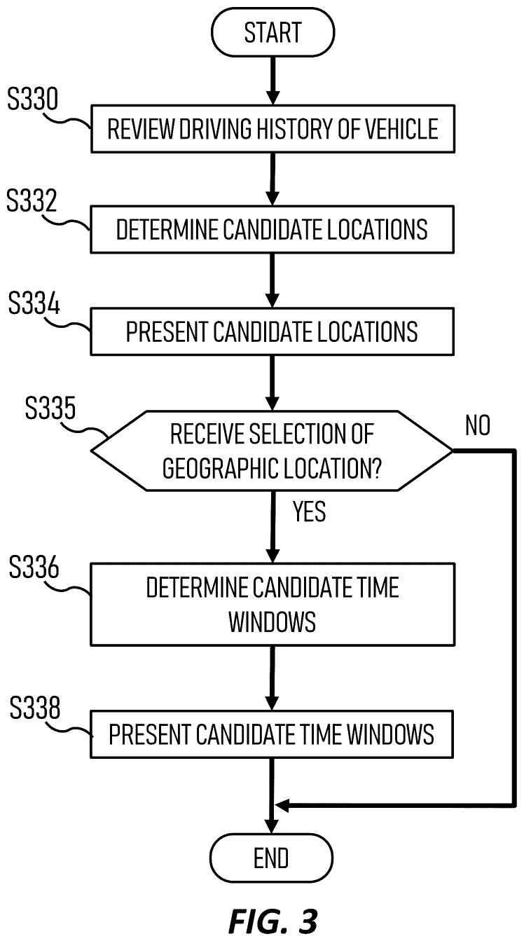

At S220, a displaying section of the processor displays a user interface. In at least some embodiments, the displaying section displays a user interface configured to receive a selection of geographic location for download performance. In at least some embodiments, the displaying section displays the user interface in response to the receiving of a download request, and the selected geographic location applies to the download request. In at least some embodiments, the determining section performs the operations shown in FIG. 3, which will be explained hereinafter.

At S222, a receiving section of the processor receives a selected geographic location. In at least some embodiments, the receiving section of a mobile computing network in a vehicle receives a selected geographic location.

At S224, the receiving section of the processor receives the download request. In at least some embodiments, the receiving section of the mobile computing network receives the download request. In at least some embodiments, the download request includes downloading applications or data related to operating system updates, entertainment, navigation, vehicle management, security and emergency, etc.

At S226, a detecting section of the processor detects a geographic location of a vehicle. In at least some embodiments, the detecting section detects a geographic location of a vehicle. In at least some embodiments, the geographic location of the vehicle is detected by a location sensor.

At S227, the processor or a section thereof determines whether the geographic location of the vehicle matches the selected geographic location. In at least some embodiments, the processor or the section thereof determines whether the geographic location of the vehicle matches the selected geographic location. In response to the processor determining that the geographic location of the vehicle matches the selected geographic location, the operational flow proceeds to determination of whether the specified priority level is higher than a threshold level at S228. In response to the processor determining that the geographic location of the vehicle does not match the selected geographic location, the operational flow proceeds back to detection of geographic location at S226.

At S228, a performing section of the processor performs the download of the download request. In at least some embodiments, the performing section performs a download of the download request in response to determining that the geographic location of the vehicle matches the selected geographic location. In at least some embodiments, the selected geographic location applies to all download requests. In at least some embodiments, selection of a download location may apply only to a download of a particular download request.

FIG. 3 is an operational flow for displaying the user interface, according to at least one embodiment of the subject disclosure. The operation flow provides a method of displaying the user interface. In at least some embodiments, the method is performed by a vehicle, such as vehicle 100 shown in FIG. 1, or a processor of an integrated circuit including sections for performing certain operations, such as the processor 450 shown in FIG. 4, which will be explained hereinafter.

At S330, the processor or a section thereof reviews the driving history of the vehicle. In at least some embodiments, the processor or a section thereof reviews driving history of the vehicle to estimate the at least one of communication speed, communication cost, or vehicular usage. In at least some embodiments, the driving history is provided based on the sensor data. In at least some embodiments, the driving history sensor data is recorded to a storage medium, such as a memory. In at least some embodiments, driving history includes tracked geographic location, time, and vehicle speed, etc. In at least some embodiments, past driving history includes population and vehicle density, which are estimated via camera recordings, image analysis, and real time data, such as live traffic data.

At S332, the determining section determines the candidate locations. In at least some embodiments, the determining section determines a plurality of candidate locations based on at least one of communication speed, communication cost, or vehicular usage. In at least some embodiments, the communication speed, communication cost and vehicular usage is estimated based on the driving history. In at least some embodiments, communication costs refer to the expenses incurred for downloading or uploading data via mobile networks. In at least some embodiments, these costs are typically calculated based on the volume of data (measured in MB or GB) and are determined by the service provider's pricing structure. In at least some embodiments, when vehicles download large amounts of data, such as significant software updates or multimedia content, communication costs can become substantial. In at least some embodiments, costs are optimized by, for example, reducing costs based on location, considering mobile plan's limits, setting download priorities and providing real-time cost information, etc. In at least some embodiments, downloading data in locations where Wi-Fi is available, such as at home or work, can help reduce reliance on mobile networks and consequently lower communication costs. In at least some embodiments, users'mobile plans may have data usage limits or additional charges for exceeding those limits. In at least some embodiments, the terms of the mobile plan are considered when scheduling downloads to avoid unnecessary costs. In at least some embodiments where communication costs are high or data limits are approaching, users can prioritize downloads based on urgency, deferring less critical downloads to manage costs effectively. In at least some embodiments, the user interface displays current data usage and anticipated communication costs in real-time to enable users to make informed decisions about data downloads. In at least some embodiments, this supplemental information enables users to manage communication costs more effectively during data downloads, promoting optimal usage and cost-efficiency. In at least some embodiments, the candidate locations are determined based on a past driving history of the vehicle or of other vehicles. In at least some embodiments, the candidate locations are determined based on live sources of data, such as live traffic data. In at least some embodiments, live sources include traffic data, etc. In at least some embodiments, candidate locations are determined based on population density or vehicle density at each location, which correlates to communication speed. In at least some embodiments, candidates with high population density and high vehicle density are less favorable candidates. In at least some embodiments, candidate locations are selected based on strength of communication line at each location.

At S334, the processor or a section thereof presents candidate locations. In at least some embodiments, the processor or a section thereof presents the plurality of candidate locations for the selection of geographic location for download performance. In at least some embodiments, candidate locations are displayed on the user interface. In at least some embodiments, candidate locations are displayed to the user upon user selection. In at least some embodiments, candidate locations are displayed to the user in response to the user requesting a download. In at least some embodiments, in response to request for an emergency call, candidate locations are prevented from being displayed.

At S335, the determining section determines whether the selection of geographic location is received. In at least some embodiments, the determining section determines whether the selection of geographic location for download performance is received. In at least some embodiments, pre-selection of a download location is not necessary. In response to the processor determining that the selection of geographic location is received, the operational flow proceeds to determination of candidate time windows at S336. In response to the processor determining that the selection of geographic location is not received, the operational flow ends.

At S336, the determining section determines candidate time windows. In at least some embodiments, the determining section determines a plurality of candidate time windows based on estimated time of arrival and duration of the vehicle. In at least some embodiments, the estimated time of arrival and duration of vehicle is determined based on the sensor data. In at least some embodiments, candidate time windows are provided by the system based on a past driving history of the vehicle or of other vehicles, and from live sources of data. For example, a home location during night is preferred, because the vehicle will be parked at the home location for a long time, however, the home location during daytime is not preferred because the vehicle might not be parked at the home location for a long time.

At S338, the processor or a section thereof present candidate time windows. In at least some embodiments, the processor or a section thereof presents the plurality of candidate time windows in response to receiving the selection of geographic location for download performance. In at least some embodiments, whether or not to download data is decided based on a combination of the geographic location and the time windows (time of day). In at least some embodiments, within a selected geographic location, certain times may not be desirable for downloading. In at least some embodiments, the user optionally selects time windows.

FIG. 4 is a block diagram of a hardware configuration for downloading data at specified locations, according to at least some embodiments of the subject disclosure.

The exemplary hardware configuration includes mobile computing network 440, which interacts with touchscreen display 480 directly or through network 482. In at least some embodiments, mobile computing network 440 is a network of a computer or other computing device of a vehicle that receives input or commands from touchscreen display 480. In at least some embodiments, mobile computing network 440 is a computer system that executes computer-readable instructions to perform downloads based on priorities.

Mobile computing network 440 includes a processor 450, a storage unit 460, an input/output interface 470, and a communication interface 472. In at least some embodiments, processor 450 is a processor or programmable circuitry executing instructions to cause the processor or programmable circuitry to perform operations according to the instructions. In at least some embodiments, processor 450 includes analog or digital programmable circuitry, or any combination thereof. In at least some embodiments, processor 450 includes physically separated storage or circuitry that interacts through a protocol. In at least some embodiments, storage unit 460 includes a non-volatile computer-readable medium capable of storing executable and non-executable data for access by processor 450 during execution of the instructions. Communication interface 472 transmits and receives data from network 482. Input/output interface 470 connects to various input and output units, such as touchscreen display 480, via a parallel port, a serial port, a keyboard port, a mouse port, a monitor port, a touch screen, a connection with a mobile device and the like to accept commands and present information. In some embodiments, storage unit 460 is external from mobile computing network 440.

Processor 450 includes displaying section 452, receiving section 454, detecting section 456, determining section 458 and performing section 459. Storage unit 460 includes download requests 462, geographic locations 464, time windows 466, driving history data 468, and sensor data 469.

Displaying section 452 is the circuitry or instructions of processor 450 configured to display a user interface. In at least some embodiments, displaying section 452 is configured to display a user interface configured to receive a selection of geographic location for download performance. In at least some embodiments, displaying section 452 is configured to present a plurality of candidate locations for the selection of geographic location for download performance. In at least some embodiments, displaying section 452 is configured to present a plurality of candidate time windows in response to receiving the selection of geographic location for download performance. In at least some embodiments, displaying section 452 utilizes information in storage unit 460, such as download requests 462, geographic locations 464 and time windows 466. In at least some embodiments, displaying section 452 includes sub-sections for performing additional functions, as described in the foregoing flow charts. In at least some embodiments, such sub-sections are referred to by a name associated with a corresponding function.

Receiving section 454 is the circuitry or instructions of processor 450 configured to receive selected geographic locations and download requests. In at least some embodiments, receiving section 454 is configured to receive a selection of geographic location for download performance. In at least some embodiments, receiving section 454 is configured to receive a selected geographic location. In at least some embodiments, receiving section 454 utilizes information in storage unit 460, such as download requests 462 and geographic locations 464. In at least some embodiments, receiving section 454 includes sub-sections for performing additional functions, as described in the foregoing flow charts. In at least some embodiments, such sub-sections are referred to by a name associated with a corresponding function.

Detecting section 456 is the circuitry or instructions of processor 450 configured to detect geographic locations. In at least some embodiments, detecting section 456 is configured to detect a geographic location of the vehicle. In at least some embodiments, detecting section 456 utilizes information in storage unit 460, such as geographic locations 464 and sensor data 469. In at least some embodiments, detecting section 456 includes sub-sections for performing additional functions, as described in the foregoing flow charts. In at least some embodiments, such sub-sections are referred to by a name associated with a corresponding function.

Determining section 458 is the circuitry or instructions of processor 450 configured to determine candidate locations and candidate time windows. In at least some embodiments, determining section 458 is configured to determine the plurality of candidate locations based on at least one of communication speed, communication cost, or vehicular usage. In at least some embodiments, determining section 458 is configured to determine the plurality of candidate time windows based on estimated time of arrival and duration of the vehicle. In at least some embodiments, determining section 458 is configured to determine whether the geographic location of the vehicle matches the selected geographic location. In at least some embodiments, determining section 458 utilizes information in storage unit 460, such as geographic locations 464, time windows 466, driving history data 468 and sensor data 469. In at least some embodiments, determining section 458 includes sub-sections for performing additional functions, as described in the foregoing flow charts. In at least some embodiments, such sub-sections are referred to by a name associated with a corresponding function.

Performing section 459 is the circuitry or instructions of processor 450 configured to perform downloads of the download requests. In at least some embodiments, performing section 459 is configured to perform a download of the download request in response to determining that the geographic location of the vehicle matches the selected geographic location. In at least some embodiments, performing section 459 utilizes information in storage unit 460, such as download requests 462 and geographic locations 464. In at least some embodiments, performing section 459 includes sub-sections for performing additional functions, as described in the foregoing flow charts. In at least some embodiments, such sub-sections are referred to by a name associated with a corresponding function.

In at least some embodiments, the apparatus is another device capable of processing logical functions in order to perform the operations herein. In at least some embodiments, the processor and the storage unit need not be entirely separate devices, but share circuitry or one or more computer-readable mediums in some embodiments. In at least some embodiments, the storage unit includes a hard drive storing both the computer-executable instructions and the data accessed by the processor, and the processor includes a combination of a central processing unit (CPU) and RAM, in which the computer-executable instructions are able to be copied in whole or in part for execution by the CPU during performance of the operations herein.

In at least some embodiments where the apparatus is a computer, a program that is installed in the computer is capable of causing the computer to function as or perform operations associated with apparatuses of the embodiments described herein. In at least some embodiments, such a program is executable by a processor to cause the computer to perform certain operations associated with some or all of the blocks of flowcharts and block diagrams described herein.

At least some embodiments are described with reference to flowcharts and block diagrams whose blocks represent (1) steps of processes in which operations are performed or (2) sections of a processor responsible for performing operations. In at least some embodiments, certain steps and sections are implemented by dedicated circuitry, programmable circuitry supplied with computer-readable instructions stored on computer-readable media, and/or processors supplied with computer-readable instructions stored on computer-readable media. In at least some embodiments, dedicated circuitry includes digital and/or analog hardware circuits and include integrated circuits (IC) and/or discrete circuits. In at least some embodiments, programmable circuitry includes reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

In at least some embodiments, the computer readable storage medium includes a tangible device that is able to retain and store instructions for use by an instruction execution device. In some embodiments, the computer readable storage medium includes, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In at least some embodiments, computer readable program instructions described herein are downloadable to respective computing/processing devices from a computer readable storage medium or to an external computer or external storage device via a network, for example, the Internet, a local area network, a wide area network and/or a wireless network. In at least some embodiments, the network includes copper transmission cables, optical transmission fibers, wireless transmission, routers, firewalls, switches, gateway computers and/or edge servers. In at least some embodiments, a network adapter card or network interface in each computing/processing device receives computer readable program instructions from the network and forwards the computer readable program instructions for storage in a computer readable storage medium within the respective computing/processing device.

In at least some embodiments, computer readable program instructions for carrying out operations described above are assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In at least some embodiments, the computer readable program instructions are executed entirely on the user's computer, partly on the user's computer, as a stand-alone software package, partly on the user's computer and partly on a remote computer or entirely on the remote computer or server. In at least some embodiments, in the latter scenario, the remote computer is connected to the user's computer through any type of network, including a local area network (LAN) or a wide area network (WAN), or the connection is made to an external computer (for example, through the Internet using an Internet Service Provider). In at least some embodiments, electronic circuitry including, for example, programmable logic circuitry, field-programmable gate arrays (FPGA), or programmable logic arrays (PLA) execute the computer readable program instructions by utilizing state information of the computer readable program instructions to individualize the electronic circuitry, in order to perform aspects of the subject disclosure.

While embodiments of the subject disclosure have been described, the technical scope of any subject matter claimed is not limited to the above-described embodiments. Persons skilled in the art would understand that various alterations and improvements to the above-described embodiments are possible. Persons skilled in the art would also understand from the scope of the claims that the embodiments added with such alterations or improvements are included in the technical scope of the invention.

The operations, procedures, steps, and stages of each process performed by an apparatus, system, program, and method shown in the claims, embodiments, or diagrams are able to be performed in any order as long as the order is not indicated by “prior to,” “before,” or the like and as long as the output from a previous process is not used in a later process. Even if the process flow is described using phrases such as “first” or “next” in the claims, embodiments, or diagrams, such a description does not necessarily mean that the processes must be performed in the described order.

In at least some embodiments, downloading data at specified locations is performed by displaying a user interface configured to receive a selection of geographic location for download performance; receiving, by a mobile computing network in a vehicle, a selected geographic location; receiving, by the mobile computing network, a download request; detecting a geographic location of the vehicle; and performing a download of the download request in response to determining that the geographic location of the vehicle matches the selected geographic location.

The foregoing outlines features of several embodiments so that those skilled in the art would better understand the aspects of the present disclosure. Those skilled in the art should appreciate that this disclosure is readily usable as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that various changes, substitutions, and alterations herein are possible without departing from the spirit and scope of the present disclosure.

What is claimed is:

1. A method comprising:
displaying a user interface configured to receive a selection of geographic location for download performance;
receiving, by a mobile computing network in a vehicle, a selected geographic location;
receiving, by the mobile computing network, a download request;
detecting a geographic location of the vehicle; and
performing a download of the download request in response to determining that the geographic location of the vehicle matches the selected geographic location.

2. The method of claim 1, wherein the displaying the user interface includes presenting a plurality of candidate locations for the selection of geographic location for download performance.

3. The method of claim 2, wherein the displaying the user interface further includes determining the plurality of candidate locations based on at least one of communication speed, communication cost, or vehicular usage.

4. The method of claim 3, wherein the displaying the user interface further includes reviewing driving history of the vehicle to estimate the at least one of communication speed, communication cost, or vehicular usage.

5. The method of claim 1, wherein the selected geographic location applies to all download requests.

6. The method of claim 1, wherein
the displaying the user interface is in response to the receiving the download request; and
the selected geographic location applies to the download request.

7. The method of claim 1, wherein the displaying the user interface includes presenting a plurality of candidate time windows in response to receiving the selection of geographic location for download performance.

8. The method of claim 7, wherein the displaying the user interface further includes determining the plurality of candidate time windows based on estimated time of arrival and duration of the vehicle.

9. A device comprising:
a processor including circuitry configured to
display a user interface configured to receive a selection of geographic location for download performance;
receive, by a mobile computing network in a vehicle, a selected geographic location;
receive, by the mobile computing network, a download request;
detect a geographic location of the vehicle; and
perform a download of the download request in response to determining that the geographic location of the vehicle matches the selected geographic location.

10. The device of claim 9, wherein the processor displays the user interface includes the processor being configured to present a plurality of candidate locations for the selection of geographic location for download performance.

11. The device of claim 10, wherein the processor displays the user interface further includes the processor being configured to determine the plurality of candidate locations based on at least one of communication speed, communication cost, or vehicular usage.

12. The device of claim 11, wherein the processor displays the user interface further includes the processor being configured to review driving history of the vehicle to estimate the at least one of communication speed, communication cost, or vehicular usage.

13. The device of claim 9, wherein the selected geographic location applies to all download requests.

14. The device of claim 9, wherein
the processor displays the user interface is in response to the receiving the download request; and
the selected geographic location applies to the download request.

15. The device of claim 9, wherein the processor displays the user interface includes the processor being configured to present a plurality of candidate time windows in response to receiving the selection of geographic location for download performance.

16. A non-transitory computer-readable medium having instructions recorded thereon that are executable by one or more processors to perform operations comprising:
displaying a user interface configured to receive a selection of geographic location for download performance;
receiving, by a mobile computing network in a vehicle, a selected geographic location;
receiving, by the mobile computing network, a download request;
detecting a geographic location of the vehicle; and
performing a download of the download request in response to determining that the geographic location of the vehicle matches the selected geographic location.

17. The non-transitory computer-readable medium of claim 16, wherein the displaying the user interface includes presenting a plurality of candidate locations for the selection of geographic location for download performance.

18. The non-transitory computer-readable medium of claim 17, wherein the displaying the user interface further includes determining the plurality of candidate locations based on at least one of communication speed, communication cost, or vehicular usage.

19. The non-transitory computer-readable medium of claim 18, wherein the displaying the user interface further includes reviewing driving history of the vehicle to estimate the at least one of communication speed, communication cost, or vehicular usage.

20. The non-transitory computer-readable medium of claim 16, wherein the selected geographic location applies to all download requests.
